(19) United States
(12) Patent Application Publication
(10) Pub. No.: US 2014/0220078 A1
(43) Pub. Date: Aug. 7, 2014

(54) Method for Preparing Glucans Based on Aspergillus niger

(71) Applicant: KitoZyme, Herstal (BE)

(72) Inventors: Philippe Richard Vaesen, Saint Remy (BE); Olivier Yvette Marcel Baum, Tilff (BE)

(73) Assignee: KITOZYME, Herstal (BE)

(21) Appl. No.: 13/823,951

(22) PCT Filed: Oct. 11, 2012
(86) PCT No.: PCT/EP2012/070184

§ 371 Date: Mar. 15, 2013

Related U.S. Application Data
(60) Provisional application No. 61/548,454, filed on Oct. 18, 2011.

(30) Foreign Application Priority Data
Oct. 11, 2011 (FR) 1159196

(51) Int. Cl. C08B 37/00; C08B 37/08

(52) U.S. Cl. CPC C08B 37/0006; C08B 37/003
USPC 424/274.1; 536/123.12; 536/53

(57) ABSTRACT

This application concerns a method for preparing glucan from Aspergillus niger, characterised in that it comprises (i) the at least partial deacetylation of the mycelium of A. niger; (ii) acid treatment of the (partially) deacetylated mycelium, preferably following purification and/or washing, to obtain insoluble glucan and soluble chitosane, which acid treatment comprises placing the deacetylated mycelium in contact with an acidic solution; (iii) the separation of the soluble chitosan on the one hand, and the insoluble glucan on the other; (iv) alkaline treatment of the glucan comprising placing the glucan in contact with an alkaline solution to cause the glucans to flocculate; and (v) drying the flocculated glucans to obtain glucan powder.

This invention further concerns the glucans thus obtained, compositions comprising them, and their uses. The glucans of the invention may be used as immunostimulants.

This invention concerns a method for preparing glucans based on Aspergillus niger, the beta-glucans thus obtained, and their uses.

The preparation of beta-glucans from various natural substrates has long been known to the art, e.g., beta(1,4)glucans arising from cereals, beta(1,3)(1,6)glucans from yeast and fungi. In particular, it is particularly known to prepare glucans from yeasts, typically Saccharomyces cerevisiae. Patent EP 0759 089 describes various beneficial effects for fish and other animals from the glucans derived from Saccharomyces cerevisiae. Various chemical or biochemical treatments are carried to eliminate beta-(1-6) glucan chains, in particular with beta-(1-6)-glucanase treatment. These treatments are intended to improve the immunostimulant activity of the glucans by increasing the proportion of glucans with beta(1-3) bonds, which are believed connected to the aforementioned activity. However, the literature indicates significant structural differences depending on the origin of the glucans. Typically, reference can be made to the article by Novak (Novak et al., Development of Views on Beta-Glucan Composition and Structure, Biology and Chemistry of Beta Glucans, vol. 01,2011,1-9). This article teaches that glucan preparations are heterogeneous depending on the organism used to extract them. Due to this heterogeneity, it is difficult to know the exact structure of glucans and to draw any hasty conclusions related to their properties, in particular their biological properties. In particular, the degree of branching of their side chains on the beta-glucan skeleton depends on genus, species, and strain of the organism in question. The degree of branching is important to the macromolecular structure of glucans, which is related to their immunostimulant properties.

Aspergillus niger is principally known as a source of chitin to produce chitosan. The mycelium of Aspergillus niger is a byproduct of the fermentation of A. niger for the production of citric acid. Methods for producing chitosan from A. niger are described, e.g., in international application WO03068824 by KitoZyme. Glucans are an insoluble byproduct obtained during the preparation of chitosan. The glucans resulting from the preparation of chitosan are discarded. This can be seen from the teaching of international applications WO0168714 and WO03086281, which do not envision any further treatment of insoluble glucans.

A priori, there is no specific study concerning the glucans obtained from Aspergillus niger. As described above, the complex structure of glucans does not allow for conclusions to be drawn on the immunostimulant properties of glucans originating from Aspergillus niger. All conclusions in this regard would be mere speculation.

On the other hand, although the glucans can be obtained as an insoluble byproduct during the preparation of chitosan, the methods known to date do not allow for industrial exploitaton of the glucans coproduced with the chitosan obtained from chitin. Additionally, the purity of the glucans is generally not satisfactory. The method for preparing chitosan in international application WO03068824 by KitoZyme does not allow for obtaining glucans with satisfactory purity, as the glucans are in the form of chitin-glucan copolymers. This international application indicates that a chitin-glucan copolymer can have 30-50% (m/m) chitin and 50-70% beta-glucans. However, this is a polymer with bonds between the chitin and the glucans. This produces chitin-bonded glucans in the form of a copolymer. To produce chitosan from chitin, the chitin is transformed using an alkaline solution in “aggressive” conditions in oder to deacetylate the chitin. These conditions indicate that the glucans obtained as a byproduct will have a sufficiently deterioriated structure that they could not be used as immunostimulant glucans, which explains the fact that this fraction is discarded in the prior art.

In this application:

“Aspergillus niger glucans” or “glucans from Aspergillus niger”, or “glucans originating from Aspergillus niger” or “glucans arising from Aspergillus niger”, refers to beta-glucans obtained or capable of being obtained from the organism Aspergillus niger, in particular from the Aspergillus niger mycelium. This designation can be transposed to other products than glucans, e.g., chitosan or chitin.

On the other hand, this invention refers to “glucans”, but this term more specifically concerns an Aspergillus niger extract comprising a majority by mass of glucans, with the remainder of the extract consisting of impurities within the meaning of the invention, i.e., compounds other than glucans.

“Glucans” and “beta-glucans” are used synonymously herein.

“Immunostimulant glucans” refers to glucans with properties that promote the immunostimulation of at least one reference marker of the immune system, e.g., neutrophils of the innate immune system.

This invention seeks to provide an industrial method for preparing glucans from Aspergillus niger.

This invention seeks in particular to improve the yield of a method for preparing glucans from Aspergillus niger. This invention seeks in particular to improve the yield of a method for preparing glucans from Aspergillus niger with the coproduction of chitosan. This invention also seeks to purify glucans from Aspergillus niger according to an industrial method.

Additionally, this invention seeks to obtain or prepare immunostimulant glucans, in particular to stimulate the immune system of an animal or a human, in particular by oral administration, application to the skin, etc.

It has been found, surprisingly, that the above objectives can be met by this invention.

In particular, the invention concerns a method for preparing glucan from the mycelium of Aspergillus niger, comprising: (i) the at least partial deacetylation of the mycelium of Aspergillus niger; (ii) acid treatment of the (partially) deacetylated mycelium, preferably following purification and/or washing, to obtain insoluble glucan and soluble chitosan, which acid treatment comprises placing the deacetylated mycelium in contact with an acidic solution; (iii) the separation of the soluble chitosan on the one hand, and the insoluble glucan on the other; (iv) alkaline treatment of the glucan comprising placing the glucan in contact with an alkaline solution to cause the glucan to flocculate; and (v) drying the flocculated glucan to obtain glucan powder.

The glucan of the invention is never 100% pure, but does comprise secondary substances. Of note amongst the secondary substances are ashes, lipids, chitin, and/or chitosan, or other polysaccharides (e.g., mannon), which one seeks to minimise in order to improve purity based on the intended use. “Deacetylating the chitin” refers to the total or partial deacetylation of the chitin, as chitosan may comprise a more or less elevated degree of acetylation.

Deacetylation Step (i)

Advantageously, deacetylation (step (i)) is carried out by placing the mycelium in contact with an alkaline material, preferably donating hydroxide ions, and preferably with sodium hydroxide (NaOH), at a concentration, at a temperature, and for a period of time sufficient to deacetylate the chitin in chitosan, preferably with a minimum concentration of 4% chitosan, and preferably greater than 9%, obtaining a chitosan preferably having a degree of acetylation, i.e., a molar proportion of N-acetyl-D-glucosamine units along the chitosan chains, of 0-50%, and preferably 10-25%. According to a preferred embodiment, the alkaline solution comprises a concentration greater than 40% (mass/volume) of alkaline matter donating hydroxide ions in proportion to the total mass of the alkaline solution. “Yield” refers to: the mass ratio expressed in % of the dry mass of the fraction containing the chitosan (chitosan and its impurities) of the original dry mass of the mycelium. For example, a sodium hydroxide solution with a concentration of 50 (mass/volume) is used.

In one variant, the mycelium of Aspergillus niger is mixed with a concentrated alkaline solution. Preferably, the alkaline solution is selected from an aqueous sodium or potassium hydroxide solution, or carbonate or bicarbonate of soda. Advantageously, the mass ratio of the alkaline matter to the chitin is 0.1-5, and preferably 0.3-3, more preferably 0.5-1.5 (m/m).

Preferably, the alkaline solution treatment of the Aspergillus niger mycelium is carried out at a temperature of 50-120° C., more preferably 80-120° C.

The mycelium can first be placed in contact with the alkaline solution, and the temperature can then be progressively increased. For example, the temperature reaches 110° C. in 2 hours, and is then maintained for 6 hours; then, the suspension obtained is transferred to the next step in 1 hour, with the temperature dropping to room temperature.

According to another preferred embodiment, the deacetylation step itself is carried out for 30 min-10 hours, preferably 3-8 hours.

It is preferable to carry out a deacetylation with a high temperature and reaction time to increase the chitosan yield (as shown in table 3 of the examples). For example, the deacetylation can be carried out by placing the mycelium in contact with the alkaline solution for 4-7 hours, then increasing the temperature to maintain a temperature of 50-120° C., more preferably 80-120° C.

The insoluble fraction in the alkaline environment can be separated from the soluble fraction by filtration and/or centrifugation.

The insoluble alkaline fraction obtained following deacetylation is preferably suspended, then diluted, filtered, and washed with water. This/these step(s) is/are typically carried out as many times as necessary.

Preferably, the alkaline solution is recovered following this first step, concentrated, recycled, and reused to deacetylate the chitin.

Prior to the deacetylation step, the method of the invention may comprise pretreatment of the A. niger mycelium. The mycelium is preferably washed, and concentrated and/or dried. According to one variant, this allows for the use of a mycelium that is totally or partially discoloured. The white or beige colour may be advantageous for applications such as pharmaceuticals, nutraceuticals, cosmetics, or in the food industry. A filtered/washed mycelium advantageously contributes to improving the chitosan and/or glucan yield.

Step (ii): Acid Treatment

This step is carried out in conditions that allow for obtaining a soluble and an insoluble fraction. The insoluble fraction in the alkaline environment is placed in contact with an acidic solution according to step (ii), with the pH advantageously set to below 6.5, and preferably below 5.5, by adding an acid, such as one chosen from hydrochloric acid, lactic, formic, glutamic, phthalic, succinic, glycolic, citric, and (preferably) acetic acid. The reaction may be carried out, e.g., at room temperature or any other temperature that promotes the separation of the soluble fraction containing the chitosan from the insoluble fraction containing the glucan.

An acidic solution with a concentration of 0.1-1 N can be used as the acidic solution. For example, an 80% acetic acid solution is used.

Advantageously, the acid treatment of step (ii) comprises the addition of an organic acid until a pH of 3-5.5, preferably 3.5-4.5 is reached.

Preferably, the acid treatment of step (ii) comprises or consists of the addition of acetic acid to the deacetylated mycelium obtained in step (i), washed, dried, and/or concentrated, as applicable.

Preferably, prior to step (ii), the alkaline residue is eliminated by means of several washings with water.

Step (ii): Separation of Glucan and Chitosan

Preferably, the separation according to step (iii) is carried out by means a continuous nozzle centrifuge. More specifically, for this centrifugation step, a nozzle separator- or self-cleaning disc stack centrifuge (e.g., NA7), or BTUX a high-performance nozzle separator vortex centrifuge can be used (these two centrifuge types, NA7 or BTUX, are marketed by Westfalia and AlfaLaval respectively).

According to one variant, the method of the invention may comprise an additional step (iiia) of treating the soluble chitosan obtained in step (iii) to separate the insoluble glucan, which may be repeated one or more times. The insoluble glucan obtained according to this additional step (iiia) may be added to the insoluble glucan recovered in step (iii).

According to a preferred variant, step (iiia) uses a centrifuge force decanter (e.g., a Sédicanteur marketed by Flottweg, which, compared to a traditional decanter, has a biconical bowl and a higher centrifuge speed than a classical decanter). Such a decanter comprises a full bowl centrifuge and a conveyor worm. It may typically reach a centrifugal force of 6000-10,000 g. The bowl speed, the worm speed, as well as the layer height are determined by persons skilled in the art to optimise the performance of the machine.

Step (Iv): Separation of Chitosan and “Flocculation Conditioning” of Glucan

The glucan according to the invention is insoluble in water at room temperature and acidic pH (below 7). The chitosan is soluble under these conditions. The insolubility of glucans allows for their purification. The floculation stage advantageously allows for separation of glucans by industrial means and in a time frame that allows for profitable industrial exploitation.

It was surprisingly found in this invention that mere treatment with a sodium hydroxide solution before drying does not allow for satisfactory separation of the liquid. In particular, it was found that the product obtained by placing the insoluble extract obtained according to step (iii) in contact is not sufficiently mechanically resistant to carry out a satisfactory solid/liquid separation. The product is denatured, and a satisfactory percentage of glucan cannot be recovered in the final extract. By carrying out the flocculation step according to the invention, the product is made more mechanically resistant in a solid-liquid separation step. The glucans can be at least partially dehydrated, eliminating the water more easily, and thus recover a final extract with a lower ash content and thus a higher glucan content.

Preferably, the alkaline solution used in flocculation step (iv) comprises or consists of lime, e.g., in the form of lime milk with 30% (Ca(OH)₂) (calcium hydroxide), which precipitates as an easily recoverable solid and resists the mechanical conditioning constrains, allowing for glucan recovery with an ultimately satisfactory degree of purity.

According to one variant, the alkaline solution of flocculation step (iv) comprises or consists of a mixture of sodium hydroxide (NaOH) and lime milk (Ca(OH)₂). When such a sodium hydroxide/lime mixture (calcium hydroxide) is used, a sodium hydroxide/lime (calcium hydroxide) mass ratio of 1/2-1/10, preferably approximately 1/2-1/6 (preferably approximately 1/3.5) is preferred.

This step is preferably monitored or verified by pH measurement. It is preferable to stop adding the alkaline solution when the pH exceeds 9, preferably exceeds 10.

The flocculation of glucan is important to allow for a separation that can be easily industrially exploited. It is preferable to use a sodium hydroxide/calcium hydroxide mixture in order to limit the donation of calcium ions in the glucans to avoid generating excess ashes. The presence of lime advantageously allows the glucans to be given a texture that facilitates their separation in industrial equipment. This also allows for a decrease in separation time, which is of great interest industrially.

It is important to carry out the flocculation step to improve the productivity and purity of the resultant glucans. This flocculation step is also important to allow for drying the glucan (by means of a flash dryer) in powder form.

Generally, following the flocculation step, the glucan is present in the form of an alkaline suspension (pH greater than 10).

Step (iva): Supplementary Glucan Purification

The glucan obtained in step (iv) may (optionally) be purified again before the drying step in order to adapt the purity of the glucan to the intended use, in particular to increase the purity, e.g., by reducing the residual ash content of the glucan. This additional step comprises placing the glucans in contact with a solution to solubilise the chitosan and then eliminate the chitosan solubilised by separation.

This supplementary purification step is advantageous if one wishes to increase the proportion by mass of glucan beyond 80% compared to the total mass of the final product.

The supplementary purification step preferably comprises placing the flocculated glucans in contact with an acidic solution.

Preferably, the acidic solution in question has a pH greater than 5 and less than 7, more preferably between 6 and 6.6. Preferably, acetic acid is used to prepare this acidic solution.

Separation can be carried out by filter press or decanter, basket centrifuge, high centrifugal force decanter (Sédicanteur 0), or band filter.

The glucan obtained can then be dried in accordance with step (v).

Step (v): Drying the Glucan

This step is advantageously carried out by inserting the glucan obtained in the previous step (step (iv) or (iva)) into a dryer in order to eliminate residual liquids.

These devices are known to persons skilled in the art.

Advantageously, drying of the glucan (“flash dryer”) can be used to obtain a fine, beige-to-light-brown powder.

This drying may be followed by granulation. The final product is then packaged.

Between each aforementioned step, i.e., between steps (i) and (ii), (ii) and (iii), (iii) and (iv), and/or (iv) and (v), it is possible to carry out various treatments. These treatments may consist, e.g., of one or more washings, purifications, concentrations, separations, and/or one or more other treatments intended to improve yield and/or purification of the products obtained according to the method of the invention.

According to one variant, the method of the invention does not comprise a step of oxidising the glucan.

The method of the invention allows for improvement of the chitosan yield by transforming a maximum amount of chitin into chitosan (“deacetylation”) whilst recovering glucan in a satisfactory fashion, preferably in order to use it as an immunostimulant.

According to another aspect, th is invention concerns a method for co-preparing chitosan and glucan from A. niger, comprising the preparation of glucan according to the aforementioned method of preparation, including all particular variants and embodiments, combined, as applicable, and the preparation of chitosan.

According to another aspect, in particular, the invention concerns a method for the production of chitosan and glucans from chitin originating from A. niger, comprising the following steps: (a) placing the chitin in contact with a basic solution to at least partially deacetylate the chitin and recover a soluble fraction in an alkaline environment and an insoluble fraction in an alkaline environment, (b) placing the insoluble fraction in alkaline environment in contact with an acidic solution to obtain a soluble chitosan fraction that is more or less acetylated and an insoluble fraction comprising glucans, followed by (c) additional treatment of the chitosan to wash it, purify it, and, if applicable, dry it, also comprising the treatment of the glucans obtained in step (b) to wash, purify, and, if applicable, dry them.

The various steps (i)-(v), including their variants, also apply to this aspect.

The soluble fraction in alkaline environment obtained after step (a) is generally discarded, because it contains various salts, proteins, and soluble hydrolysed glucans.

According to one variant, the soluble chitosan obtained in step (b) can be placed in contact with an enzyme of the type of chitin deacetylase to obtain chitosan.

The chitosan prepared may have a high molecular mass. The chitosan may also have a low-medium or medium molecular mass.

“Low molecular mass” refers to an average molecular mass below 100,000. “High average molecular mass” refers to a chitosan with an average molecular mass greater than 100,000. Preferably, the chitosan has a very low average molecular mass, i.e., less than 50,000. Preferably, the chitosan has an average molecular mass of 10,000-50,000. The average molecular masses are determined by measurement with an Ubbelohde capillary viscosimeter or by steric exclusion chromatography with light diffusion detection (SEC-MALLS), or by triple detection (e.g., with the Viscotek Triple Detector Array max system). It is possible to hydrolyse the chitosan in order to reduce its molecular mass.

Advantageously, the chitosan is obtained by controlling the degree of acetylation. “Chitosan with a controlled degree of acetilation” refers to a product having a degree of acetylation, i.e., the proportion of N-acetyl-glucosamine units, that can be adjusted in a controlled fashion.

For the treatment of chitosan, it is possible to refer, in particular, to the conditions described in WO03068824 by KitoZyme.

It is also worth emphasising that, according to a preferred embodiment, the method of the invention for extracting glucan and chitosan from A. niger mycelium lasts less than 12 hours, and preferably less than 10 hours.

Beta-Glucan

According to another aspect, the invention concerns beta-glucan from A. niger that can be obtained by a method such as that defined by the invention, including all particular variants and embodiments, or combinations thereof, as applicable.

According to one variant, the glucan of the invention is suited for animal feed, in particular, it has a composition suited for animal feed. In particular, the glucan has a glucan content greater than 50%, preferably greater than 55%, and more preferably greater than 60%, in particular for animal feed.

According to another variant, the glucan of the invention is suited for use in humans, in particular for oral or dermal administration, in particular food, cosmetic, and/or pharmaceutical grade. Preferably, the glucan has a purity greater than 70%, preferably greater than 75%, and more preferably greater than 80%, in particular for human applications. These percentages are expressed in glucan mass per total mass of wet product. “Wet product” refers to the finished product with its residual water content, which is 4-10% according to a preferred variant.

Following analysis of the glucan obtained, it was found that it has a majority of glycoside bonds between the beta-(1,3) glucose units. Very surprisingly, it was found, in particular, that the method of the invention preserves the bioactivity of the glucan obtained, i.e., its capacity to modulate the immune system. As mentioned above, the literature shows that the activity of beta(1,3)-glucan strongly depends on its structure (glycoside bonds, branchings, etc.), which may be affected by the treatments it undergoes. Contrary to what one might think, despite the highly hydrolysing conditions used for the deacetylation of chitin in chitosan, the glucan obtained according to the method of the invention has an immunomodulatory activity, as shown by oral administration in the fish Pimephales promelas, the parameters of the innate immune system of which are under study.

Preferably, the glucan obtained has a high proportion of beta-(1-3) glycoside bonds, e.g., greater than 70% of the total number of bonds of the glucans. It is known that, the greater the proportion of beta-(1-3), the better the immunostimulant properties.

This glucan is advantageously obtained without using a beta-glucanase enzyme.

Preferably, the glucan of the invention comprises less than 15% by mass of chitosan compared to the total mass of the wet product. Such glucans are satisfactory for oral administration in animals. According to one embodiment, the glucan of the invention comprises less than 10% by mass of chitosan compared to total mass of the wet product. These glucans are suited for skin or oral administration in humans.

The percentage by mass of chitosan present in the glucan can be analysed based on the method of extraction of the chitosan by precipitation/washing/weighing.

Preferably, the glucan of the invention comprises less than 10% ash. It is also possible to obtain 5% ash, and possibly less than 3% ash compared to the mass of the wet product.

Preferably, the glucan of the invention comprises less than 5% by mass of lipids, and less than 1% proteins, compared to the total mass of the wet product.

Preferably, the glucan of the invention comprises no detectable chitin. The presence of chitin can be detected by the method of dosing sugar following hydrolysis and derivatisation, as described in the examples.

Immunomodulatory Properties

The invention further concerns beta-glucan from A. niger for the modulation of the immune system of a human or an animal.

An animal to which the glucan of the invention can be administered is typically selected from livestock, race animals (horses, dogs), companion animals, and aquaculture fish.

According to one variant, the glucan is intended to improve the functioning of the immune system, e.g., the neutrophils, with regard to oral administration, and the Langerhans cells with regard to application on skin.

According to another variant, the glucan is intended to increase the degranulation capacity and activity of neutrophils.

The invention further covers a food supplement composition for humans or animals, comprising glucan from A. niger as defined above, including all particular variants and embodiments, and optionally combinations thereof.

The invention further covers solid food for fish, characterised in that it comprises glucan from A. niger as defined above. Typically, such food comprises a substance providing starch, a substance providing proteins, a substance providing lipids, possibly a mixture of antibiotics, and possibly a mixture of minerals and vitamins, possibly antioxidants, possibly digestive enzymes, possibly probiotic microorganisms, and possible prebiotic fibres. The substances providing starch are generally derived from cereals, such as soya, maize, wheat, oats, or barley. The protein-providing substances are, e.g., fish meal, soya meal, or a dehydrated whey, soya proteins, soya flour, blood meal, plasma proteins, dehydrated skim milk, whey protein concentrate, colza flour, maize gluten flour, wheat gluten flour, yeasts, or sunflower meal. The lipid-providing substances are generally selected from soya oil, lecithin, coconut oil, whey lipids, lard oil, or mutton fat.

The invention further covers a pharmaceutical composition comprising glucan from A. niger as defined above.

The invention further covers a pharmaceutical composition comprising glucan from A. niger as defined above.

The invention further covers a cosmetic composition comprising glucan from A. niger as defined above.

According to another aspect, the invention concerns the use of glucans for applications in the medical, pharmaceutical, nutraceutical, cosmetic, agricultural, agribusiness, textile, and/or environmental fields.

General Use of Chitosan and Glucan—Formulations

The chitosan obtained according to the method of the invention may be used in various applications, typically such as those described in KitoZyme application WO03068824.

The chitosan and glucan obtained according to the method of the invention may be used in the form of micro-, or nanoparticles that may be prepared using techniques known to persons skilled in the art (e.g., Polymeric Biomaterials, S Dimitriu ED, Marcel Dekker, 2002, Chap. 1).

The glucan of this invention is essentially directly insoluble in any solvent at 25° C. at atmospheric pressure. The glucan may be prepared in the form of a powder of freeze-dryed fibres.

The glucan of the invention may be mixed with one or more active ingredients, and one or more excipients. Thus, the invention further covers a formulation comprising the glucan of the invention.

The glucan of the invention may be prepared in the form of capsules, tablets, powder, gel, film, emulsion, or suspension. The glucan may also be included in delivery systems, e.g., vectors, to be administered at the level of the small intestine. The glucan may be included in food matrices, e.g., bars, beverages, baked goods, or dairy products.

According to one variant, the glucan of the invention may be formulated in a composition for topical administration. This may be, in particular, cosmetic or pharmaceutical compositions for topical administration (applied to a keratinous material, e.g., the skin). Such compositions may comprise cosmetically or pharmaceutically active ingredients (active ingredients) and/or topically acceptable excipients known to persons skilled in the art in the field of cosmetics or pharmacy. Specific examples of formulations according to the invention that comprise the glucan are oil-in-water and water-in-oil emulsions. The invention covers lipsticks and lip balms containing the glucan.

For better formulation in compositions applicable to the skin and to allow for a pleasant feeling of a homogeneous composition without visually or dermally detectable solids, the glucan according to this invention is preferably micronised, i.e., reduced to the size of particles of glucan or containing glucan having a dimension less than one millimetre, preferably less than 500 microns. It is advantageous for the diameter of 70%, and preferably 90%, of the particles to be less than 350 microns (d(0.7)<355 μm, preferably d(0.9)<355 μm), preferably less than 100 microns, in particular for oil-in-water and water in oil emulsion formulations, and preferably less than 50 for lipsticks and lip balms. The granulometry is that obtained by laser diffractometry.

According to one variant, the glucan may be used after sifting.

For example, a fish food composition is formulated in the form of a gel comprising a pre-mix of powder with 50% proteins and vitamin C mixed with hot water (90° C.) at a ratio of 1:1, to which the compounds of the invention, e.g., at a concentration of 0.1-5 g/kg food are added. The gel formed following mixing is typically granulated (0.1-1 mm) just before use to feed the fish.

In the drawings:

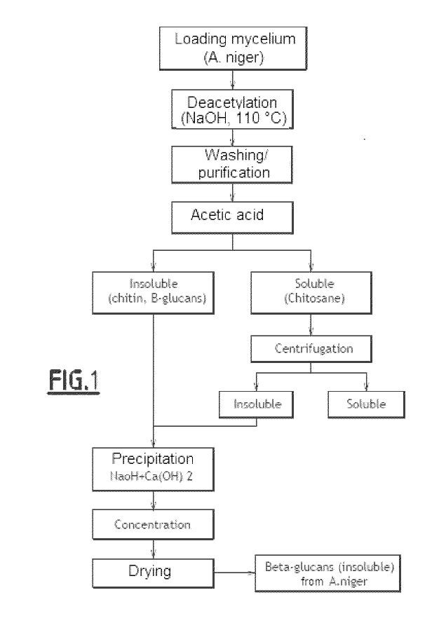

FIG. 1 shows a schematic diagram of a variant of the method of the invention comprising steps (i)-(v);

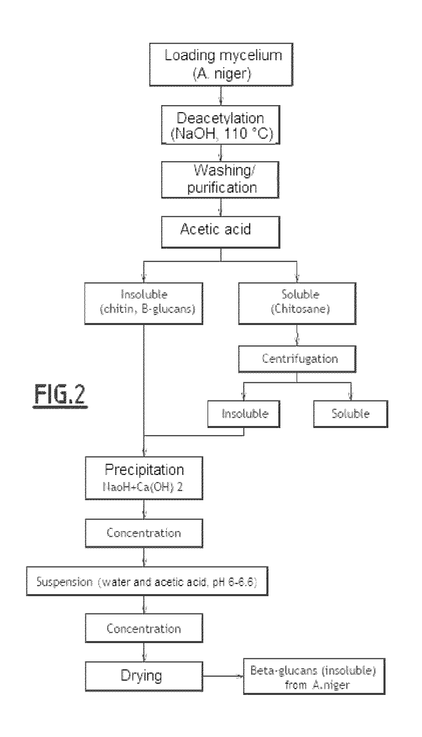

FIG. 2 shows a schematic diagram of another variant of the method of the invention comprising steps (i)-(v), and additional purification of the glucans according to step (iva);

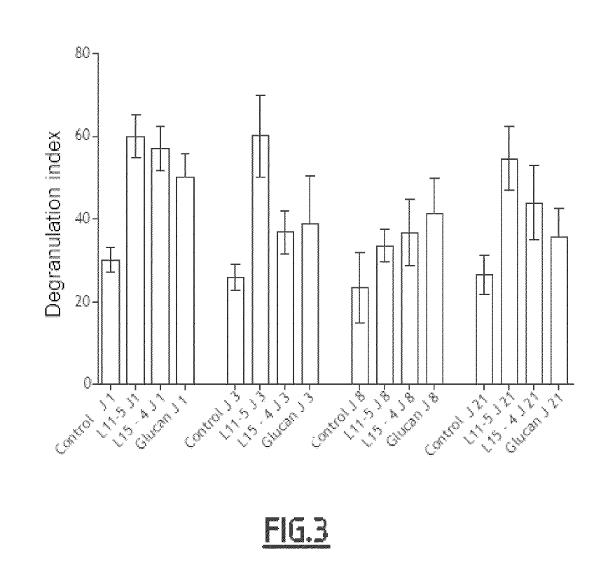

FIG. 3 shows a degranulation histogram of the primary neutrophil granules following supplementation of fish with beta-glucans L11 (5 g/kg food), L15 (4 g/kg), and beta glucans from yeast (glucan=L04, 5 g/kg) for 8 days, without applying stress to the fish;

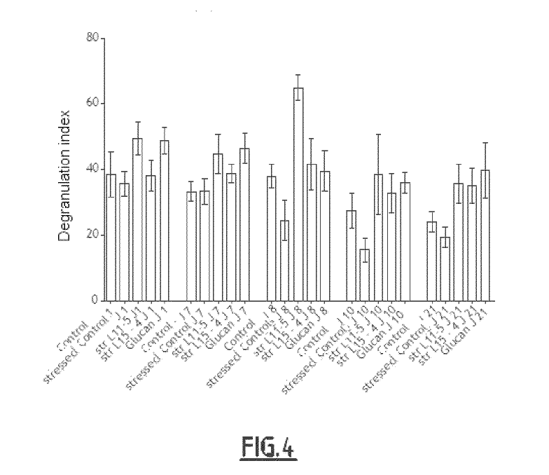

FIG. 4 shows an oxidative burst index histogram following supplementation of fish with beta-glucans L11 (5 g/kg food), L15 (4 g/kg), and beta glucans from yeast (glucan=L04, 5 g/kg) for 8 days, with stress applied to the finish after day 7;

FIG. 5 shows the development of the CD54 marker in a monocyte population as a function of the beta-glucan concentration in the environment;

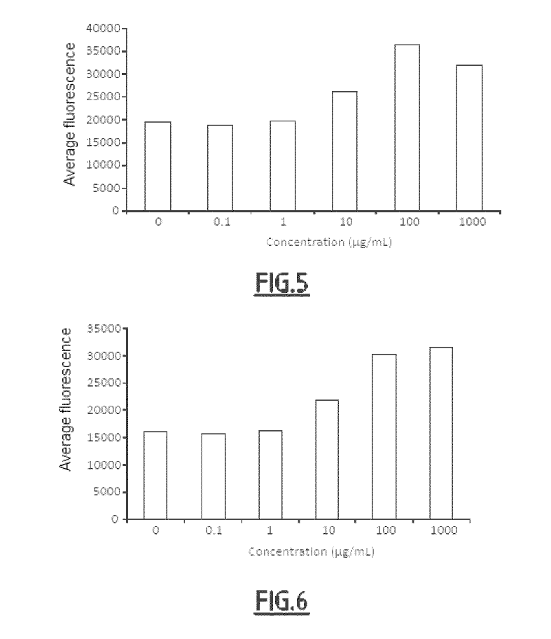

FIG. 6 shows the development of the CD54 marker in a plasmacytoid dendrite cell population as a function of the beta-glucan concentration in the environment;

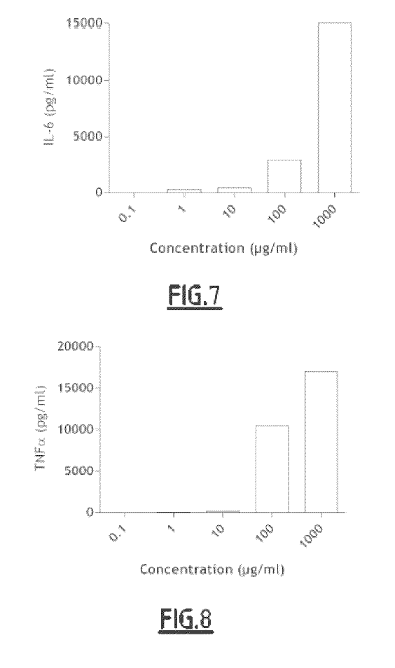

FIG. 7 shows the production of interleukin 6 (IL-6) as a function of the beta-glucan concentration;

FIG. 8 shows the production of tumour necrosis factor alpha (TNF-α) as a function of the beta-glucan concentration;

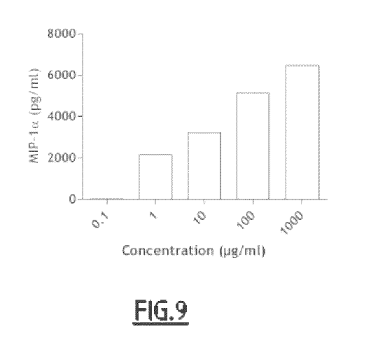

FIG. 9 shows the production of macrophage inflammatory protein 1 alpha (MIP-1α) as a function of the beta-glucan concentration;

Other objectives, characteristics, and advantages of the invention will become clear to persons skilled in the art following a reading of the detailed description by reference to examples provided for illustration only, and which shall not be construed in any way as limiting the scope of the invention.

The examples are an integral part of this invention, and any and all characteristics that appear novel compared to any prior art based on the description taken as a whole, including the examples, is incorporated by reference into the invention both functionally and generally.

Thus, each example is general in scope.

On the other hand, in the examples, all percentages are given by weight unless otherwise noted, and the temperature is expressed in degrees Celcius unless otherwise indicated; pressure is atmospheric pressure, unless otherwise indicated.

### EXAMPLES

### Analytic Methods

Dosage of Beta-Glucan Content

The beta-glucan content is determined using an enzymatic method, according to a method adapted from that of the Megazyme kit (reference K-EBHLG). The validation of the method carried out using the E-noval software (Arlenda) calculated an uncertainty of ±3% for the value and an acceptance limit of ±10%.

1—A quantity of 20 mg+/−0.1 mg beta-glucan powder was suspended in a volume of 0.4 ml 2N potassium hydroxide solution with stirring for 30 min in an ice bath.

2—The pH of the suspension is then adjusted to 4.0-4.5 by adding a sodium acetate solution with a concentration of 1.2 M at pH 7.

3—The mixture is incubated with a mixture of enzymes exo-1,3-β-glucanase, endo-1,3-β-glucanase, β-glucosidase, and chitinase in suspension (Megazyme) for 16 hours at 40° C.

4—Following dilution and centrifugation, an aliquot is collected to determine the glucose content with the GOPOD reagent (consisting of glucose oxidase plus peroxidase and 4-aminoantipyrine diluted in a buffer consisting of p-hydroxybenzoic acid and sodium azide).

External calibration is carried out with a solutions of glucans from yeasts (Megazyme) with a concentration of 0, 5, 10, 15, 20, and 25 mg in a volume V of 2N sodium hydroxide solution having gone through steps 1-4 above.

The beta-glucan content is determined by measuring the absorbency by UV spectrometry by comparison with the calibration curve.

The beta-glucan content is expressed in g beta-glucan per 100 g wet beta-glucan.

Dosage of Water Content

The loss on desiccation is determined using a thermogravimetric method based on the method of the European Pharmacopoeia 2.2.32 (Desiccation Loss) with a precision of ±0.15% of the value. The modification with respect to the Pharmacopoeia method concerns the choice of equipment (humidity analyser in lieu of a heat chamber) without any significant impact on the value and obtaining of the results.

In brief, a known quantity of beta-glucan powder is heated to 105° C., and the loss of mass is measured continuously using a calibrated humidity analyser (Ohaus MB 45) until a value below 1 mg is obtained for 90 seconds. When this value is obtained, the weight of the desiccation loss is calculated by subtracting the value of the dry matter from the total mass.

The water content is expressed in g water per 100 g wet beta-glucan.

Dosage of Ash Content

The method for analysing the ash content is based on that of the European Pharmacopoeia 2.4.16. A porcelain crucible is weighed. A known quantity of beta-glucan is placed in the porcelain crucible and heated for 10 h at 600° C. in a calibrated muffle furnace (Carbolite, 201). Following combustion, the porcelain crucible containing the beta-glucan from the sample is weighed. The ash content is expressed in g beta-glucan per 100 g wet beta-glucan. The ash content is expressed in g beta-glucan per 100 g wet beta-glucan.

Dosage of Protein Content

The protein content is determined by a method based on the total hydrolysis of proteins and spectrophotometric dosage, having the following steps:
1—1 g beta-glucan powder is suspended in a volume of 10 ml concentrated (10 N) sodium hydroxide solution prepared from sodium hydroxide R (European Pharmacopoeia) at 130° C. for 90 min.
2—The beta-glucan solution thus hydrolysed is then neutralised to pH 6.9-7.1, and the total volume adjusted to 50 ml.
3—100 μl of this solution is sampled, and 1 ml of 0.5 M acetate buffer at pH 5.1 is added.
4—1 ml ninhydrin/hydrindantin solution (500 mg ninhydrin and 150 mg hydrindantin in 100 ml monoethylic ethylene glycol ether) is then added to the solution prepared in step 3 (1.1 ml) to form a complex absorbing at the wavelength of 570 nm.
5—The absorbance of this solution is measured by spectrophotometry with a spectrophotometer calibrated according to the European Pharmacopoeia 2.2.25 (Absorption Specrophotometry, Ultraviolet and Visible).

An external calibration curve is established with a bovine serum albumin solution (BSA, BioChemika, fraction V, lot no. S41084, Fluka) at concentrations of 0, 2, 4, 6, and 8 mg, having undergone the same steps 1-5 as the beta-glucan.

The protein content is expressed in g water per 100 g wet beta-glucan.
The validation of the method is carried out using the E-novalet software, with an uncertainty of ±10% for the value method and an acceptance limit of ±25%.

Dosage of Lipid Content

The determination of the lipid content is based on Regulation (EC) 152/2009 of 27-01-2009. The uncertainty as to the value is ±0.7%. The lid content is expressed in g water per 100 g wet product.

Characterisation of the Proportions in Sugar-Type Repetition Unit

The sugars are composed by gas chromatography of the sugars following solubilisation by total hydrolysis of the beta glucan and derivatisation of the sugars according to the methods described in Merkle and Poppe (1994) Methods Enzymol. 230: 1-15 et York, et al. (1985) Methods Enzymol. 118:3-40.
1—0.3 mg beta-glucan powder is methanolysed with 1 M hydrochloric acid in methanol at 80° C. for 16 hours.
2—The samples are then treated with Tri-Sil (Pierce) at 80° C. for 30 min.

The resultant derivatives (per-O-trimethylsilyl-TMS) are analysed by gas chromatography by comparison with an external calibration curve made with a standard for each sugar.

The sugar content is expressed in g sugar per 100 g wet beta-glucan having been solubilised by hydrolysis.

Characterisation of Chaining between Repetition Units

The glycoside chains between glucose units were analysed in accordance with the method described by York et al. (1985)—Methods Enzymol. 118:3-40).
1—3 mg beta-glucan powder is solubilised in dimethylsulphoxide.
2—The samples are then partially methylated according to the method described by Ciukan and Kerek (1984) in Carbohydr. Res. 131:209-217, with butyl-lithium and methyl iodide: The samples are treated with sodium hydroxide for 15 min followed by methyl iodide treatment for 45 min (this method is carried out twice).
3—The complex is then hydrolysed by reaction with 2M trifluoroacetic acid (2 h at 121° C.)
4—The complex is then acetylated using a mixture of trifluoroacetic acid/acetic anhydride
5—The complex concentration is determined by gas chromatography with mass spectrometry detection, by comparison with an external calibration curve made with a standard for each sugar.

The glycoside bonds between the glucose units are expressed in g per 100 g of each individual wet sugar identified (in this case, glucose).

### Example 1

### Preparation of Aspergillus niger Mycelium

The mycelium of Aspergillus niger is a byproduct of the fermentation of citric acid.

Following the fermentation stage, the mycelium is passed through a belt press filter in order to be pressed and washed. The mycelium coming out of the belt press has a percentage of 18% dry matter by mass. The mycelium is then dried in a rotary dryer, followed by a pneumatic dryer (flash dryer type).

Composition of the Mycelium

The mycelium of A. niger is in accordance with the specifications of Table 1.

TABLE 1

| Analysis | Specification |
|---|---|
| Water (%) | ≦10% |
| Ash (% wet mass) | ≦2% |
| Proteins (% wet mass) | ≦10% |
| Lipids (% wet mass) | ≦1% |

The type of mycelium of A. niger may have an influence on the purity of chitosan. The example presented above shows the difference in yield and purity between two mycelia, the one not washed following collection of the citric acid (black in colour), the other pressed/washed following citric acid collection (beige in colour).

TABLE 2

| | Non-washed | Pressed/washed |
|---|---|---|
| | mycelium | mycelium |
| Yield of reaction | 4.4% | 9.6% |
| (% m/m dry | | |
| mycelium) | | |

Composition and characteristics of the chitosan

| | | |
|---|---|---|
| Ash (% m/m wet | 2.8% | 0.5% |
| mass) | | |
| Proteins (% m/m | NE | 0.3% |
| wet chitosan) | | |
| Glucan (% m/m) | 5.4% | 13.7% |
| Degree of | 21.7% | 24.0% |
| acetylation | | |
| (mol %) | | |
| Apparent | 3.7 | 5.4 |
| viscosity in 1% | | |
| solution (v/m) | | |
| (mPa · s) | | |
| Turbidity of 1% | 491 NTU | 27 NTU |
| solution (v/m) | | |
| (NTU) | | |
| Colour of 1% | Light brown | Light beige |
| solution (v/m) | | |

In comparing the chitosans, it is notable that a greater yield is obtained from the pressed/washed mycelium. In terms of purity, the colouration of the chitosan obtained from the non-washed mycelium is also darker. The turbidity of a 1% chitosan solution (v/m) in 1% acetic acid is also higher than that of a chitosan solution obtained from pressed/washed mycelium. The glucan content when using the pressed/washed mycelium may be reduced below 10% by mass compared to the total mass of chitosan.

### Example 2

### Industrial Co-Preparation of Chitosan an Glucans

Initial tests were carried out in the laboratory.

The following deacetylation reaction conditions for the chitin contained in the mycelium were tested.

TABLE 3

| Reference | A | | B | | C | |
|---|---|---|---|---|---|---|
| Temperature | 110° | C. | 110° | C. | 110° | C. |
| Addition of a | 30 | ml | 37.5 | ml | 30 | ml |
| 50% NaOH | | | | | | |
| solution | | | | | | |
| Reaction time | 3 | hr | 3 | hr | 7 | hr |
| Mass of | 30 | g dry | 30 | g dry | 30 | g dry |
| mycelium | | | | | | |

According to these conditions, the following characteristics of chitosan and glucan can be obtained:

TABLE 4

| Reference | A | B | C |
|---|---|---|---|
| Mass of | 2.35 g dry | 1.95 g dry | 3 g dry |
| recovered | | | |
| chitosan (g) | | | |
| Yield (%) | 7.8% | 6.5% | 10.0% |
| Glucan (% m/m) | 17.7% | 26.3% | 12.0% |
| Degree of | 32.7% | 38.9% | / |
| acetylation | | | |
| (mol %) | | | |
| Apparent | 4.7 | 4.35 | / |
| viscosity | | | |
| (mPa · s) | | | |
| Glucan yield | ND | ND | 6.54 g |

It will be noted that the deacetylation conditions have an effect on the yields of chitosan and glucan.

The results show that it is preferable to use deacetylation reaction conditions with greater temperature and duration to increase the chitosan yield.

The conditions that provide the best chitosan yields, and are thus applied at industrial scale in the following examples, are as follows: 6 hours of deacetylation, followed by an increase in temperature up to 110° C. for 2 hours, followed by maintenance of this temperature for 6 h, followed by transfer of the reaction mixture for 1 h.

The purity of the chitosan obtained is suitable for the intended applications. Furthermore, these conditions allow for preservation of a large part of the insoluble glucan and thus their recovery.

For an industrial method, a conical mixer can be used, e.g., for the invention, a 4 m3 conical mixer equipped with a double envelope allowing for the reaction mix to be heated to 120° C. The agitation of the mixture is ensured by a feeder screw mounted on an orbital arm covering the periphery of the reactor at approximately 2 rpm.

Glucan/Chitosan Separation—Industrial Equipment

Once the deacetylation has been carried out, the soda is removed by washing with water. Following these washing steps, the suspension is set to pH 4 by adding concentrated acetic acid. The chitosan is soluble, and the glucan insoluble, under these conditions.

To separate the two fractions, various industrial equipment was tested. Preferably, a nozzle centrifuge is used, in particular a high-performance vortex nozzle stacked disc centrifuge (BTUX). Persons skilled in the art optimise the settings of this equipment to separate more efficiently the chitosan from the glucan, in particular taking into account the chitosan and glucan yield and their respective purities.

The settings of the BTUX nozzle centrifuge are made in order to concentrate the glucan sufficiently so that a minimal part of the chitosan remains in the insoluble fraction that includes the glucan (table 5).

TABLE 5

| | | | | |
|---|---|---|---|---|
| BTUX feed pump seed in % compared to | 15% | 20% | 25% | 30% |
| maximum speed of 12 m³/h | | | | |
| Insoluble fraction in filtrate following | 0.5% | 15% | 25% | 30% |
| centrifugation (% v/v) | | | | |
| Soluble fraction content in insoluble fraction | 25% | <5% | <5% | <5% |
| centrifugation (% v/v) | | | | |

The proportions are measured following centrifugation by determining the volumes in a test tube.

The percentage of insolubles in the filtrates corresponds to the quantity of glucans remaining in the chitosan solution.

In this example, the best setting of the BTUX is that at which the pump operates at a speed of 20% of the maximum speed, as indicated by the elevated glucan concentration (<95%) which reveals a limited loss of chitosan. The last fraction of glucan present in the chitosan solution (15%) is separated by passing it through an equipment of the “Sedicanter” type. The pump speed is set based on the quantity of insolubles present in the soluble fraction (chitosan) and the concentration of the insoluble fraction (glucan). A proportion of insolubles of 8-12% in the filtrates is envisioned. This setting allows obtaining low soluble fraction content in the low insoluble fraction (<5%).

For an industrial method, a nozzle centrifuge can also be used. The nozzle centrifuge is a solid/liquid separator. The solid/liquid suspension is separated using high-speed rotation (HFA 8000 rpm/BTUX 7000 rpm) of a bowl allowing for the separation of the fine solid particles from the liquid phase and their concentration via nozzles. This high-speed separation is potentiated by an elevated filtration surface (discs).

In order to increase the glucan yield, the soluble fraction containing the chitosan and any residual glucan is passed through an elevated centrifugal force separation decanter such as a “Sedicanter”.

The Sedicanter/decanter is a solid/liquid separator. The solid/liquid suspension is separated using high-speed rotation (Sedicanter 4800 rpm/decanter 3500 rpm) of a bowl allowing for the separation of the fine solid particles from the liquid phase and their evacuation by means of a feeder screw placed inside the bowl.

The settings are thus made in order to optimise the recovery of glucan without significantly affecting the soluble fraction comprising the chitosan from the purity and yield standpoint.

### Example 3

### Recovery of Glucan

Objective: The conditions of this treatment allow for recovery of the entirety of the glucans exiting the BTUX and the Sédicanteur. The objectives are increased productivity and acceptable purity (glucan content>60%).

The choice of the method of precipitation has a significant effect on the productivity of the production line and the purity of the glucan. In fact, precipitation with only sodium hydroxide does not allow for easy separation in the filter press.

To promote separation, precipitation using lime milk was tested. This type of additive allows for flocs to be obtained (by flocculation). This type of texture of the precipitate allows for easier separation in industrial equipment and advantageous reduction of the separation time.

Preferably, a mixture of sodium hydroxide/lime is used to flocculate the glucan at a pH of approximately 10.

The proportion of soda to lime in the mixture recovered is varied on the laboratory scale in order to determine how to limit the contribution of calcium in the final glucan (table 6).

TABLE 6

| Additive | | | NaOH/CaO mixture | | |
|---|---|---|---|---|---|
| type | NaOH | CaO | No. 1 | No. 2 | No. 3 |
| Volume of | 11 ml/ | 28 mL/ | 4 ml soda | 7 ml soda | 11 ml soda |
| additive | kg | kg | 30% | 30% | 30% |
| added per | | | 14 ml lime | 18 ml lime | 36 ml lime |
| kg glucans | | | milk 30% | milk 30% | milk |
| exiting | | | | | |
| BTUX | | | | | |
| Dryness | 13 | 20 | 22 | 16.4 | 14.6 |
| (%) | | | | | |
| Final pH | >10 | >10 | >10 | >10 | >10 |
| of glucan | | | | | |
| fraction | | | | | |
| following | | | | | |
| preci- | | | | | |
| pitation | | | | | |
| Ash (% | >15% | >15% | <10% | >10% | >10% |
| m/m wet) | | | | | |

Dryness corresponds to the percentage by mass of dry matter compared to the total mass of the cake recovered following concentration, typically with a press filter.

On the laboratory scale, these conditions of test no. 1 are the best: 1.6 g NaOH and 4.2 g de CaO (mass ratio approximately 1/2.5).

The resultant product has an ash content less than 10%, which is suited for animal feed.

It is important to eliminate the aqueous phase sufficiently before passing through the flash dryer to obtain substantial purity of the glucan.

The glucans are then concentrated in a filter press, decanter, belt filter, or basket centrifuge in order to be able to dry them.

Industrially, it is preferred to carry out the concentration using a filter press:

The filter press is a solid/liquid separator. It allows for separation under pressure of a suspension by frontal filtration of solid particles through a filtering medium (synthetic sheets) maintained between 2 rigid plates. The space 2 rigid plates allows for collection of the dehydrated solid portion using the internal pressure of the filter. The clarified liquid portion is recovered via a transverse tube collecting the filtrate of each filtration medium.

The concentrated solution is dried in a flash dryer.

The flash dryer is a drying device that allows for the recovery of a fine powder based on a compact, wet product. The wet product is fed via a feeder screw in the drying chamber. In this drying chamber, a hot air flow affects and dries the solid particles and carries them through a classifier. The rotational speed of the classifier allows for verification of the size of the dry particles; if they are too large, they fall back into the drying chamber, which is equipped with a grinder, where they are ground and again carried away by the air flow. Once they have passed through the classifier, the air flow and the particles are separated in a cyclone. The fine powder is recovered under the cyclone, and the air is filtered through a filter bag to be sent outside.

### Example 4

### Industrial Production of Beta-Glucan Suited for Animal Feed

In this example, 2.77 m3 of glucan was treated following separation in the nozzle centrifuge (BTUX). This glucan solution, with a pH of 3.5-4.8 (acetic acid), is treated by adding soda and lime to reach a pH greater than 10 (mass ratio soda/lime of 1/5.6 (12 l 30% soda and 90 l 30% lime, i.e., 4.8 and 27 kg, respectively)). The soda is added to allow a pH greater than 4.8 to be attained; then, the lime is added to attain a precipitate in the form of flocs (pH 10).

The glucan thus precipitated was concentrated by a filter press in order to eliminate water and obtain the glucan in solid form at approximately 20% dry matter. Following this concentration step, it is fed into the flash dryer in order to recover 155 kg reference glucan powder L15.

The characteristics of the glucan thus produced are described in table 7.

TABLE 7

| | L11 |
|---|---|
| Glucan (% m/m wet) | 60 |
| Water (% m/m wet) | 5 |
| Ash (% m/m wet) | 9 |
| Proteins (% m/m wet) | 0.15 |
| Lipids (% m/m wet) | 3.8 |

### Example 5

### Additional Purification of Glucan on the Industrial Scale

The glucan is resuspended in water after being precipitated and concentrated. The pH is set between 6 and 7 by adding acetic acid in order to solubilise the remaining chitosan. The suspension is sent by separation, e.g., in a filter press.

In this example, 4 m³ of glucan was treated following separation in the nozzle centrifuge (BTUX). This glucan solution, with a pH of 3.5-4.8 (acetic acid), was treated by adding soda and lime to reach a pH greater than 10 (15 l 30% NaOH and 701 lime milk). The glucan thus precipitated was injected into a filter press for concentration. The glucan was resuspended in a tank with 10 m³ osmosis-purified water. The pH of the suspension was adjusted to 6.4 with a volume of 17180% acetic acid.

The suspension was reinjected into a filter press for concentration. The concentrated glucan was dried in the flash dryer. 150 kg reference glucan L37 was recovered.

The characteristics of the glucan thus produced are described in table 8.

TABLE 8

| | L37 |
|---|---|
| Glucan (% m/m wet) | 90 |
| Water (% m/m wet) | 3.12 |
| Ash (% m/m wet) | 1.5 |
| Proteins (% m/m wet) | 0.21 |
| Lipids (% m/m wet) | 4.1 |

### Example 6

### Preparation and Characteristics of Glucan Batches Used in the In Vivo Study of Immunomodulatory Properties

The glucans used in the studies are described in table 9. The reference glucan L11 from A. niger is that of example 4. The glucan from reference yeast “glucan” is a commercial product for animal feed.

The reference glucan L15 from A. niger is prepared as follows on the industrial scale.

3 m³ insoluble fraction from the BTUX (step iii) is collected. The glucan solution was treated by adding 50 l 30% sodium hydroxide to reach a pH greater than 11. The glucans treated were injected into the filter press for concentration (elimination of water).

In order to reduce the ash content (sodium hydroxide), 3 m³ osmosis-purified water was injected into the filter press. The solid glucans were then dryed in the flash dryer, and 70 kg reference glucan powder L15 is collected.

TABLE 9

| | | A. niger | Yeast |
|---|---|---|---|
| | A. niger beta-glucan | beta-glucan | beta-glucan |
| | L11 | L15 | “glucan” |
| Glucan (% m/m wet) | 64.7 | 70 | 61 |
| Ash (% m/m wet) | 9.2 | 6.4 | 3.2 |
| Lipids (% m/m wet) | 3.8 | ND | ND |
| Proteins (% m/m | 0.15 | 0.2 | ND |
| wet) | | | |

### Example 7

### In Vivo Study of the Effect of Beta-Glucan from A. niger on the Functioning of the Innate Immune System of Adult Pimephales promelas Fish in the Absence of Stress and Under Stress

Pimephales promelas is commonly used as a model for toxicological and immunological studies (Russom et al. In: Environmental Toxicol Chem 16:948 (1997). Its cellular immune system is representative of the innate immune system of numerous animal species and humans.

Two beta-glucans from A. niger and products as described in examples 4 and 6 (references L11 and L15) were incorporated into powdered fish food as described by Palic et al. in Developmental Comparative Immunol 30:817 (2006), at doses of 5 g/kg and 4 g/kg, respectively. The beta-glucan from yeast (“glucan”) was incorporated into fish food at the dose of 5 g/kg.

Adult P. promelas fish were divided into various tanks depending on the food they received: Control (food alone) or food supplemented with one or the two beta-glucans, from A. niger (references L11 and L15) and a beta-glucan from yeast (reference “glucan”), or with phorbol myristate acetate (PMA, positive control).

The fish were fed every day. For half of the fish of each tank, stress was then applied 7 days after the start of the study, according to a method that imitates manipulation of the fish and their excess, as described by Palic et al. in Aquaculture 254:675 (2006). In fact, the stress causes a loss of efficacy of the innate immune defences, in particular the functions of neutrophils, e.g., the oxidative burst (massive emission of active oxygen) following stimulation by PMA and degranulation of primary granules. The test seeks to verify that the supplementation of fish with beta-glucans from A. niger allows for stimulation of neutrophil activity on the one hand, and that the pre-supplementation with beta-glucans from A. niger allows the stress-related decrease in immune defences to be avoided on the other hand.

The neutrophil activity marker is the effect on the degranulation of the primary granules of the neutrophils, which is determined by the release of myeloperoxidase (MPO) by the primary granules of the neutrophils, which were isolated upon exiting the kidneys of the fish and stimulated by ionophoric calcium according to the method described by Palic et al. in: Developmental Comparative Immunol 30:817 (2006). The supplementation of fish with the 3 types of beta-glucan (L11 at 5%, L15 at 4%, and L4 at 5%) is first studied for 21 days in normal conditions, without stress: It results in an increase in degranulation compared to the control (FIG. 3). The effects of the 2 glucans from A. niger (L11 and L15) are comparable to those of the glucan from yeast (“glucan”).

Then, the effect of the supplementation of the fish with the 3 types of beta-glucan on the reaction to stress applied on the seventh day was studied: It results in an increase in degranulation compared to the “stressed” control following the application of the stress (FIG. 4). This result confirms that the beta(1,3) glucans from A. niger are bioactive and immunostimulant at the doses administered to the fish, at a level comparable to that of a beta-glucan from yeast.

### Example 8

### Ex Vivo Study on Human Blood Cells

8.1 Beta-Glucan Used for the Study

The bega-glucan from A. niger used for this study is a grade for use in human food.

This grade may be characterised as follows (tables 10):

TABLE 10

| | Ash | Proteins | Beta-glucans |
|---|---|---|---|
| | (% mass/ | % mass/wet | % mass/wet |
| Product | wet mass) | mass) | mass) |
| Beta-glucan | 1.4% | 0.3% | 80% |

The sample was treated before the study, in particular to eliminate any bacterial endotoxins present. The sample was ground to obtain a granulometry of approximately 70 μm (d(0.9)<70 μm). It was then sterilised with ethylene oxide and then treated with NaOH to eliminate the bacterial endotoxins; the endotoxins are known to stimulate the immune system.

8.2 Activation of Immune Cells

Blood sampled from healthy volunteers was exposed for 24 h to growing quantities of glucan (grade according to example 8.1) from 0.1 mg/ml to 1000 mg/ml. The activation of immune cells was then measured with cell membrane markers, in particular CD54, by flux cryometry.

Clear monocyte (FIG. 5) and plasmacytoid dendrite activation (FIG. 6) was observed for beta-glucan according to the invention, especially when the beta-glucan was used at 100 μg/mL.

8.3 Cytokine Induction

Blood sampled from healthy volunteers was exposed for 24 h to growing quantities of glucan from 0.1 mg/ml to 1000 mg/ml.

The production of cytokines in the environment was then measured by multiplexing. The glucan according to the invention is capable of inducing interleukin 6 (IL-6) production (FIG. 7) and tumour necrosis factor alpha (TNF-α) (FIG. 8), in particular starting at 100 μg/mL, as well as macrophage inflammatory protein 1 alpha (MIP-1α) starting at 1 μg/mL (FIG. 9). The production of other cytokines, such as Granulocyte Colony Stimulating Factor (G-CSF), Granulocyte Macrophage Colony Stimulating Factor (GM-CSF), and Interleukin 1 beta (IL-1β), was also increased in the presence of beta-glucan according to the invention, following a dose-response effect.

The glucan according to the invention allows for activation of human immune cell activation and cytokine production induction, thus showing the benefits of its use as an active ingredient in an immunostimulant pharmaceutical composition for human use.

### Example 9

### Cosmetic Formulations

The glucan used in the following examples has a composition according to example 8, without further treatment to eliminate any bacterial endotoxins.

In order to prepare acceptable cosmetic formulations, i.e., for topical application, the particle size distribution of beta-glucan is preferably as follows:

The diameter of 90% (d(0.9)) of the particles is less than 350 microns, preferably less than 100 microns for oil-in-water and water-in-oil emulsions, and preferably less than 50 microns for lipsticks and lip balms (measured by laser diffractometry).

### Example 9.1

### Anti-Aging Moisturiser Composition Containing Beta-Glucan from A. niger

This formulation has the following composition:

TABLE 11

| Phase | Ingredient (INCI) | % |
|---|---|---|
| A | Dicaprylyl Ether | 5 |
| | Capylic/Capric triglyceride | 5 |
| | Cetearyl alcohol | 2 |
| B | Aqua | Ad 100% |
| | Glycerin | 8 |
| | Xanthan gum | 0.30 |
| C | Beta-glucan | 1.5% |
| | Ammonium acryloyldimethyltaurate/VP | 1.10 |
| | copolymer | |
| D | Phenoxyethanol, methylparaben and | 1* |
| | piroctone olamine | |
| | Tocopheryl acetate | 0.30 |
| E | Citric acid 10% | Suff. |

Suff. Sufficient to reach 100%.

Procedure

1. Mix the components of phase A, and melt at approximately 80° C.

2. Dissolve the ingredients of phase B together

3. Add the components of phase C to mixture 1 whilst stirring

4. Add mixtures 2 and 3 whilst stirring at 250 rpm, cool.

5. Add phase D to mixture 4 at 35° C.

6. adjust the pH of mixture 5 with phase E to a value of 6.0-6.5

7. Finish by homogenising

### Example 9.2

### Baby Lotion Containing Beta-Glucan from A. niger

This formulation has the following composition:

TABLE 12

| Phase | INCI | % |
|---|---|---|
| A | Sunflower seed oil sorbitol | 2.00 |
| | esters | |
| | Caprylic/capric triglyceride | 2.00 |
| | Dicaprylyl ether | 2.00 |
| | Prunus amygdalus dulcis | 3.00 |
| | (sweet almond) oil | |
| | Helianthus Annuus | 2.00 |
| | (sunflower) seed oil | |
| | Behenyl alcohol | 2.00 |
| | Stearyl alcohol | 2.00 |
| | Sorbitan caprylate | 1.50 |
| B | Aqua | Ad 100% |
| | Glycerin | 5.00 |
| C | Xanthan gum | 0.030 |
| D | Potassium cetyl phosphate | 0.60 |
| E | p-anisic acid | 0.30 |
| F | Beta-glucan | 1.00 |
| G | Sodium hydroxide 10% | Suff. |

Procedure
1. Mix the components of phase A, and melt at approximately 80° C.
2. Mix the ingredients of phase B
3. Add phase C to mixture 2 and mix with vigorous stirring until a clear, homogeneous solution is obtained
4. Add phase D to mixture 3, mixing well and heating to 80° C.
5. Add phase E to mixture 4 and mix with vigorous stirring until a homogeneous solution is obtained
6. Add phase F to mixture 1 at and mix.
7. Add mixture 5 to mixture 6 and mix at 300 rpm until the temperature decreases
8. Adjust the pH with phase G to 5.5
9. Finish by homogenising

Results

pH: 5.45

Viscosity (Brookfield, 20° C. at 20 rpm): 4000 mPa·s

Stability: Satisfactory after 12 weeks at room temperature (20° C.), 40° C., and 45° C.

### Example 9.3

### Moisturising Cream Containing Beta-Glucan from A. niger

This formulation has the following composition:

TABLE 13

| Phase | INCI | % |
|---|---|---|
| A | Dicaprylyl ether | 5.00 |
| | Caprylic/capric triglyceride | 5.00 |
| | Cetearyl alcohol | 2.00 |
| B | Aqua | Ad 100% |
| | Glycerin | 8.00 |
| | Xanthan gum | 0.30 |
| C | Beta-glucan | 1.00 |
| | Ammonium acryloyldimethyltaurate/VP | 1.10 |
| | copolymer | |
| D | Phenoxyethanol, methylparaben and | 1.00* |
| | piroctone olamine | |
| | Tocopheryl acetate | 0.30 |
| E | Citric acid 10% | Suff. |

Procedure

1. Mix the components of phase A, and melt at approximately 80° C.

2. Dissolve the ingredients of phase B

3. Add the components of phase C to mixture 1 whilst stirring

4. Add mixtures 2 and 3 whilst stirring at 250 rpm, cool.

5. Add phase D to mixture 4 at 35° C.

6. adjust the pH of mixture 5 with phase E to a value of 6.0-6.5

7. Finish by homogenising

Results

pH: 6.30

Appearance: Smooth white cream

Viscosity (Brookfield, 20° C. at 20 rpm): 40300 mPa·s

Stability: Satisfactory after 12 weeks at room temperature (20° C.), 40° C., and 45° C.

1. A method for preparing glucan from Aspergillus niger comprising:
(i) at least partially deacetylating the mycelium of Aspergillus niger;
(ii) placing the at least partially deacetylated mycelium in contact with an acidic solution to obtain insoluble glucan and soluble chitosan;
(iii) separating the soluble chitosan on the one hand, and the insoluble glucan on the other;
(iv) placing the glucan in contact with an alkaline solution to cause the glucan to flocculate; and
(v) drying the flocculated glucan to obtain glucan powder.

2. The method according to claim 1, wherein the alkaline solution of step (iv) comprises a mixture of sodium hydroxide (NaOH) and calcium hydroxide (Ca(OH)₂).

3. The method according to claim 1, wherein step (iv) comprises a mass ratio of sodium hydroxide/calcium hydroxide of 1/2-1/10.

4. The method according to claim 1, wherein the separation is carried out by a continuous nozzle centrifuge.

5. The method according to claim 1, wherein the method further comprising (iiia) treating the soluble chitosan obtained in step (iii) to separate the insoluble glucan, which is added to the insoluble glucan recovered in step (iii).

6. The method according to claim 1, the deacetylation is carried out by placing the mycelium in contact with an alkaline matter, in a concentration, at a temperature, and for a period of time sufficient to deacetylate the chitin in chitosan with a minimum yield of 4% chitosan and a degree of deacetylation of 0-50.

7. The method according to claim 1, wherein, prior to step (ii), the pH is decreased by one or more washings with water.

8. The method according to claim 1, wherein the acid treatment of step (ii) comprises the addition of an organic acid until a pH of 3-5.5 is reached.

9. The method according to claim 1, wherein the acid treatment of step (ii) comprises the addition of acetic acid to the mycelium deacetylated in step (i).

10. A method for co-preparing chitosan and glucan from Aspergillus niger, wherein the method comprises the preparation of glucan according to claim 1 and the preparation of chitosan.

11. Beta-glucan from Aspergillus niger obtainable by a method comprising:
(i) at least partially deacetylating the mycelium of Aspergillus niger,
(ii) providing an acid treatment to the (partially) deacetylated mycelium to obtain insoluble glucan and soluble chitosane, wherein the acid treatment comprises placing the deacetylated mycelium in contact with an acidic solution;
(iii) separating the soluble chitosan on the one hand, and the insoluble glucan on the other;
(iv) placing the glucan in contact with an alkaline solution to cause the glucan to flocculate; and
(v) drying the flocculated glucan to obtain glucan powder.

12. Animal feed grade Beta-glucan from Aspergillus niger according to claim 11.

13. Human application grade Beta-glucan from Aspergillus niger according to claim 11.

14. A method for the modulation of the immune system of a human or an animal comprising administrating a human or an animal Beta-glucan from Aspergillus niger.

15. The method according to claim 14, wherein the method improves the functioning of the innate immune system.

16. Human or animal food supplement composition comprising beta-glucan from Aspergillus niger as defined in claim 11.

17. Solid fish food comprising beta-glucan from Aspergillus niger as defined in claim 11.

18. Pharmaceutical composition comprising beta-glucan from Aspergillus niger as defined in claim 11.

19. Immunostimulant pharmaceutical composition comprising beta-glucan from Aspergillus niger as defined in claim 11.

20. Cosmetic composition comprising beta-glucan from Aspergillus niger as defined in claim 11.
